(19) United States
(12) Patent Application Publication
(10) Pub. No.: US 2003/0220823 A1
(43) Pub. Date: Nov. 27, 2003

(54) System for providing web-based case management

(76) Inventors: Peter J. Sartorius, Muskegon, MI (US); Gary R. Packingham, Muskegon, MI (US); Sterling Heibeck, Grand Rapids, MI (US)

Correspondence Address: Warner Norcross & Judd LLP, 900 Fifth Third Center, 111 Lyon Street, N.W., Grand Rapids, MI, 49503-2487, US

(21) Appl. No.: 10/107,676

(22) Filed: Mar. 27, 2002

(51) Int. Cl. G06F 17/60

(52) U.S. Cl. 705/8; 705/9

(57) ABSTRACT

A case management system providing case management within one or more communities, each community including a plurality of agencies and each agency including a plurality of users. The case management system includes an administrator component for building each community by defining at least the agencies and the users. The case management system component further includes a data collection component for entering a plurality of cases into the system, including demographic and historical data, and for associating each case with one or more users. A case management component is provided for maintenance, review and surveillance of a data concerning a specific case. The system further includes a communication component permitting communication concerning a case between users associated with the case. The case management system may also include a report generator component for creating reports relating to essentially any data collected by the system.

### BACKGROUND OF THE INVENTION

The present invention relates to system for providing case management, and more particularly to a system for providing computerized case management.

Case management can be a difficult and arduous task, requiring the collection, organization, maintenance and review of relevant information. The problems are compounded in situations where various parties are involved in the management of a particular case, and even more so when these parties are located remotely from one another and they are not using the same computer system or compatible compute languages. For example, relatively significant problems are faced in case management associated with the field of juvenile offenders, where a variety of different agencies are involved in the case management process. In many communities, the juvenile courts, local police, community mental health services, school systems, counseling agencies, and other similar service providers are involved in the case management process. In settings such as this, proper case management requires the collaboration of all agencies associated with a particular juvenile. This collaboration has proven to be largely infeasible without automation.

A variety of computerized case management systems are available to facilitate case management. These systems facilitate case management by providing a mechanism for collecting, storing, sharing and reviewing case management related data. Unfortunately, existing systems are highly complex, making it difficult to set-up and use the case management system. Often times, elaborate interfaces are needed to allow the different agencies' computer systems to communicate with each other. Accordingly, a high degree of computer sophistication is often required to administer and operate many existing systems. Further, although the complexity of such systems may provide the system with a broad range of functionality, these systems still fail to provide certain types of functionality that are desired in this field.

### SUMMARY OF THE INVENTION

The aforementioned problems are overcome by the present invention wherein a computer system is provided with an administrator component for building a case management community by defining a plurality of agencies and users; a data collection component for collecting data concerning a specific case; a case management component for maintenance, review, entry and edit of data concerning a specific case; a communication component permitting communication between users associated with a particular case; and a report generating component that permits the creation of reports relating to essentially any data collected by the system.

The system generally includes a central case management database that is maintained on a host computer and is accessible using web-based communication and web-based protocols, for example, over the Internet, an intranet or extranet.

The administrator component preferably includes a graphical user interface (“GUI”) that permits an administrator to build one or more communities, each community including a plurality of agencies and each agency including a plurality of users.

The data collection component includes a GUI that provides for collection of data from any of a number of remote users over the computer network to create a database of cases. The GUI facilitates the collection of data by providing data entry fields, pull down boxes and other data input mechanisms. The categories and type of data collected for a specific case can vary from application to application through corresponding changes in the GUI.

The case management component includes a GUI that permits review of collected data, as well as entry of additional case management data. The case management component preferably includes a calendar database that maintains time-specific case management information for each case. The time-specific information is preferably maintained in a calendar table having a separate record for each case.

The communications component permits web-based communication between users concerning a specific case. The communication may be accessible to all users associated with a case through a message board function or may be private between users through an email function.

The report generator component permits the generation of reports containing essentially any data field contained in the system databases. The data bases are preferably maintained in a relational database and reports are generated using conventional SQL queries.

The present invention provides a simple and effective computerized case management system. The system permits collection, integration, maintenance, review and surveillance and review of case management information by different users, and by different agencies. Data collected by the system is available to all users, subject to security privileges. The administrator component permits the establishment of multiple customized case management communities, each having a different array of agencies and users. The case management component permits users from different agencies to share and update data on a specific case. The case management component also permits time-specific data to be collected and maintained by the system, thereby facilitating the review and maintenance of time-based events associated with a specific case. The communications component permits users—even users at different locations—to exchange communications concerning a specific case, thereby facilitating cooperation and collaboration between users and between agencies.

These and other objects, advantages, and features of the invention will be readily understood and appreciated by reference to the detailed description of the preferred embodiment and the drawings.

### BRIEF DESCRIPTION OF THE DRAWINGS

FIG. 1 is a schematic diagram showing an overview of the present invention;

FIG. 2 is a screen shot of the agency selection GUI;

FIG. 3 is a screen shot of the contact selection GUI;

FIG. 4 is a schematic diagram of the community database;

FIG. 5 is a screen shot of a portion of one page of the data collection GUI;

FIG. 6 is a screen shot of a portion of one page of the data collection GUI with data entered;

FIG. 7 is a screen shot of the juvenile photo selection GUI;

FIG. 8 is a screen shot of a portion of another page of the data collection GUI;

FIG. 9 is a screen shot showing a portion of the summary list;

FIG. 10 is a screen shot of a portion of the profile display screen;

FIG. 11 is a screen shot of a portion of th e historical display screen;

FIG. 12 is a screen shot of a portion of the agency contact display screen;

FIG. 13 is a screen shot of the event display screen;

FIG. 14 is a screen shot of the activity notes display screen;

FIG. 15 is a screen shot of the calendar GUI;

FIG. 16 is a screen shot of the event input GUI;

FIG. 17 is a screen shot showing the activity notes input GUI;

FIG. 18 is a screen shot showing the discussion topics for a juvenile;

FIG. 19 is a screen shot showing the message reply GUI;

FIG. 20 is a screen shot showing the new topic GUI; and

FIG. 21 is a schematic diagram of the core database.

### DETAILED DESCRIPTION OF THE PREFERRED EMBODIMENT

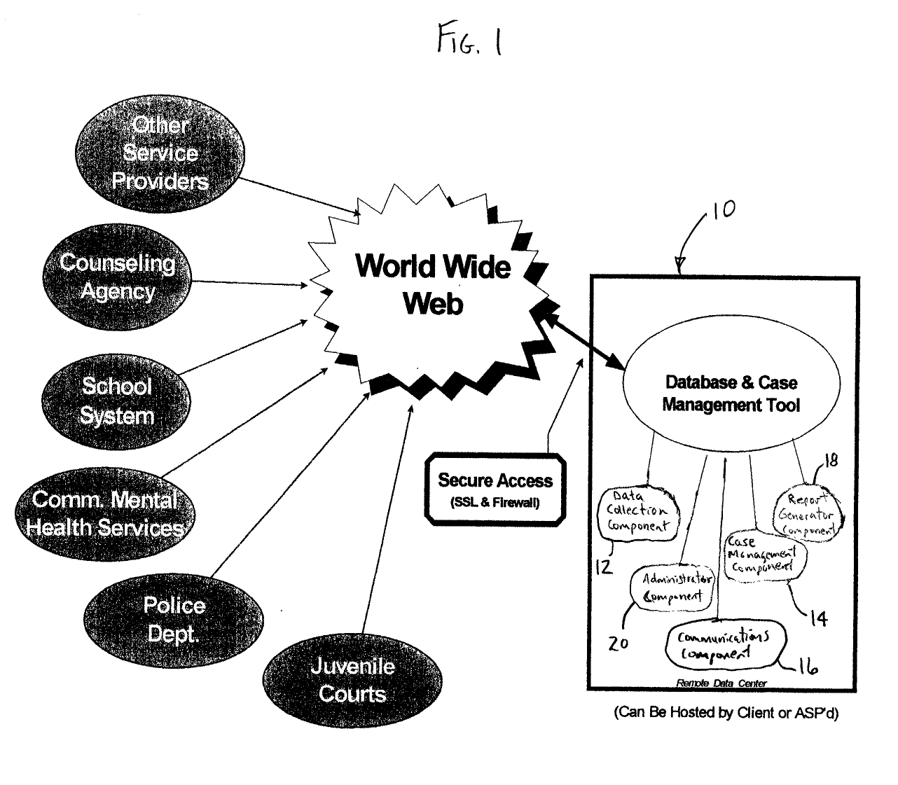

A diagram showing a general overview of a preferred embodiment of the present invention is shown in FIG. 1. By way of disclosure, and not by way of limitation, the present invention is described in connection with a case management system specifically adapted for use in managing the cases of serious habitual juvenile offenders. The present invention is, however, well-suited for use in a wide variety of case management applications. In general, the system includes a host computer 10 that is connected to the Internet so that it is accessible by users from remote locations. The host computer 10 includes a data collection component 12 that permits entry, compilation and viewing of data concerning each of a plurality of cases. The host computer 10 further includes a case management component 14 that facilitates case management by permitting web-based maintenance, surveillance and review of data collected by the system. The host computer 10 further includes a communications component 16 that provides web-based communication between users associated with a common case. The host computer 10 additionally includes a report generating component 18 that permit the generation of reports based on essentially any data collected by the system 10. The host computer 10 further includes an administrative component 20 that permit the establishment of one or more case management communities by defining a plurality of agencies and users that have access to the community. The administrator further configures the security mechanism employed by the system.

I. Hardware and Software Specifications.

The present invention is preferably implemented using a conventional client-server hardware and related technology. The host computer is preferably a conventional server running a conventional web server operating system, such as Microsoft Windows 2000 Server with Internet Information Service 5.0 and Microsoft Transaction Server with COM+support. The host computer is connected to the Internet, a local or wide area network or other similar network using conventional techniques and apparatus. The host computer is accessible via a plurality of client workstations that communicate with the host computer via the Internet, a local or wide area network or other similar network. Each client workstation is connected to the network using conventional techniques and apparatus, and is preferably loaded with conventional networking software, such as Microsoft Internet Explorer 4.0 or higher, or Netscape Version 4.0 or higher. The hardware and all related networking components are generally conventional and therefore are not described in any further detail. The host computer and client workstations preferably communicate using conventional HTTP protocol with web pages programmed using conventional HTML. In many application, the case management system will be used with highly confidential information. Accordingly, security is an important factor. In such applications, Secure Sockets Layer (SSL) or other security protocols are required from host. The present invention also preferably includes generally conventional password protected login capabilities to limit access to the system.

Additional security is providing by maintaining a database of entries concerning activity on the system. The tracking feature makes an entry in the tracking database each time a user logs in, logs out or performs a function that runs an SQL statement (e.g. performs a data entry, edit, view or retrieval function). The entry includes an identification of the user and may also include the time of the entry.

Although the present invention is described in connection with conventional web-based protocols, the present invention may also be configured to function wirelessly. This can be achieved by restructuring the web pages to comply with one or more conventional wireless protocols.

II. Case Management Software Components.

The functionality of the present invention is preferably implemented in a combination of hardware and software. The case management processes are preferably implemented in one or more computer programs executing on the host computer. The client workstations each include software capable of rendering the input and output screens communicated by the host computer, for example, the conventional web browser software specified above. The present invention preferably incorporates a variety of software components that may be created using conventional programming languages, such as SQL, C++, Visual Basic, C# or other conventional high-level programming languages. In a preferred embodiment, the present invention is constructed of, among other things, input and output web pages, database tables and SQL code commands. The development and implementation of programming code capable of caring out the functionality associated with the present invention is well within the abilities of one of ordinary skill in the field, and accordingly exemplary code is not provided and will not described in detail. The present invention is described with reference to various screen shots of a preferred embodiment of the invention. The screen shots are intended to be exemplary and not to provide any limitation on the scope of the present invention. It should be noted that, in some instances, the web page shown in a screen shot is larger than a single screen. Accordingly, certain of the screen shots represent only a portion of the displayed web page.

The present invention preferably includes five general software components. The first software component is the administrative component that permits an administrator to build one or more case management communities. This feature will give an administrator a jump point to the different administrative areas. The administrative component of the preferred embodiment preferably provides the following general functions:

Agencies

Update/add/delete

Contact Information

Juvenile assignment (Assign an agency to a juvenile)

Users

Update/add/delete

Contact Information

Agency assignment (Assign a user to an agency)

Juvenile assignment (Assign a user to a juvenile)

Security (Choose what information a user can view)

The following paragraphs provide a more detailed description of the functions of the administrative component:

A. ADD AGENCY/USER

1. Introduction

User is taken to a screen that lists all users or agencies. This screen will have a button for Adding. By clicking on the Add User or Add Agency button the user will be taken to a screen showing all information needed to add a new user to the database.

2. Inputs

User fills in the required Text Fields/Drop down boxes.

3. Processing

All required fields must be validated for proper data type.

4. Outputs

On successful validation→a) User/Agency is added to the community database.

b) Alert the User that the addition was successful.

c) Screen is cleared of data so the User may add another.

On failure of validation→User is shown what data is invalid so it may be corrected.

B. DELETE AGENCY/USER

1. Introduction

User is taken to a screen that lists all users or agencies. Next to each User or Agency will be a button labeled DELETE. Clicking this button executes this function.

2. Inputs

User clicks on the DELETE button located next to the User/Agency they wish to delete.

3. Processing

Confirm that the user does indeed wish to delete this User/Agency.

4. Outputs

On successful confirmation→User/Agency is deleted from the database.

On denied confirmation→No action is taken.

C. EDIT AGENCY/USER

1. Introduction

User is taken to a screen that lists all users or agencies. The name of each User or Agency will be highlighted as a link. By clicking on the name of the User/Agency the user will be taken to a screen to edit that User/Agencies information.

2. Inputs

This screen will look identical to the Add User/Agency screen, with the exception that data will be filled, where appropriate, with the data already gathered about this User/Agency.

3. Processing

All required fields must be validated for proper data type.

4. Outputs

On successful validation→a) User/Agency information is updated to the database.

b) Alert the User that the update was successful.

On failure of validation→User is shown what data is invalid so it may be corrected.

D. USER ASSIGNMENT

1. Introduction

This allows an administrator to determine which users belong to which agencies. This will help to determine what privileges any given user has when viewing data in the system.

2. Inputs

Administrators can add/remove users to the defined agencies.

3. Processing

Add a user(s) to the agency specified.

E. JUVENILE ASSIGNMENT

1. Introduction

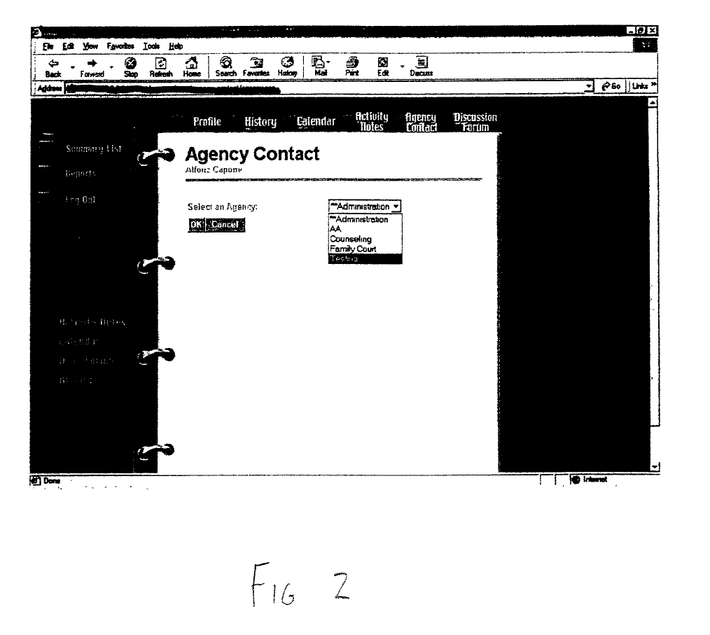

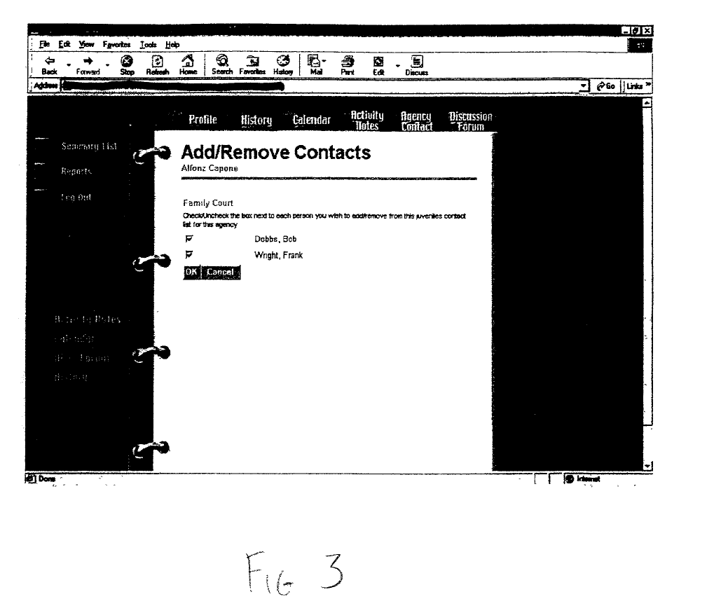

This allows an administrator to determine which agencies and/or users are assigned to a particular juvenile. This will help determine who can view a particular juvenile's data. A juvenile can be assigned to one or more agencies, and then to one or more contacts in each agency. FIG. 2 is a screen shot of an agency selection GUI. A drop down list displays all of the agencies entered into the community. Once an agency is selected for assignment, a contact screen is displayed where the individual contacts for the juvenile at that agency can be selected. FIG. 3 is a screen shot showing a contact selection GUI with check boxes for assigning contacts to the juvenile.

2. Inputs

Administrators can add/remove agencies and individual users to the defined agencies

3. Processing

Add an agency/user(s) to the juvenile specified.

F. SECURITY ASSIGNMENT

1. Introduction

This allows an administrator to determine what security privileges a given user or agency has when viewing data. In the preferred embodiment, the administrator indicates whether a specific user is permitted to read, write and/or delete data. The administrator also indicates whether a user has system administrator status or agency administrator status. System administrator status preferably permits a user to have full access to all administrator functions. Agency administrator status preferably permits a user to establish and edit the contacts and users associated with that agency, including the security assignment for each.

2. Inputs

Administrators can add/remove privileges to certain users and/or agencies

3. Processing

Add/Remove the specified privilege from the agency/user.

The administrative component also includes agency contact functions that permit contacts to be added, deleted and edited for each agency. The following paragraphs provide a more detailed description of these functions:

A. ADD AGENCY CONTACT

1. Introduction

User is taken to a screen that lists all contacts for the selected Agency. This screen will have a button for adding a new contact to the Agency. By clicking on the Add Contact button the user will be taken to a screen showing all information needed to add a new contact.

2. Inputs

User fills in the required Text Fields/Drop down boxes.

3. Processing

All required fields must be validated for proper data type.

4. Outputs

On successful validation→a) Contact is added to the database.

b) Alert the User that the addition was successful.

c) Screen is cleared of data so the User may add another.

On failure of validation→User is shown what data is invalid so it may be corrected.

B. DELETE AGENCY CONTACT

1. Introduction

User is taken to a screen that lists all contacts for the selected Agency. Next to each Contact will be a button labeled DELETE. Clicking this button executes this function.

2. Inputs

User clicks on the DELETE button located next to the User/Agency they wish to delete.

3. Processing

Confirm that the user does indeed wish to delete this Contact.

4. Outputs

On successful confirmation→Agency Contact is deleted from the database.

On denied confirmation→No action is taken.

C. EDIT AGENCY CONTACT

1. Introduction

User is taken to a screen that lists all agency contacts for the selected Agency. The name of each contact will be highlighted as a link. By clicking on the name of the contact the user will be taken to a screen to edit that contacts information.

2. Inputs

This screen will look identical to the Add Agency Contact screen, with the exception that data will be filled, where appropriate, with the data already gathered about this Contact.

3. Processing

All required fields must be validated for proper data type.

4. Outputs

On successful validation→a) Contact information is updated to the database.

b) Alert the User that the update was successful.

On failure of validation→User is shown what data is invalid so it may be corrected.

Another unique aspect of the administrator component is that it permits the color scheme of all screen displays to be controlled by activating a single “software switch” at the administrator level. This permits customization of the case management system for a particular community. Perhaps even more importantly, it permits the color scheme to be easily adjusted to accommodate the needs of one or more colorblind users. For example, if a community includes a user that has difficulty discerning between red and yellow, the color scheme can be changed to avoid the juxtaposition of these colors. This functionality is achieved by embedding global variables into the style sheets to define the colors in the various screens, and by permitting the value of these variables to be adjusted by the administrator.

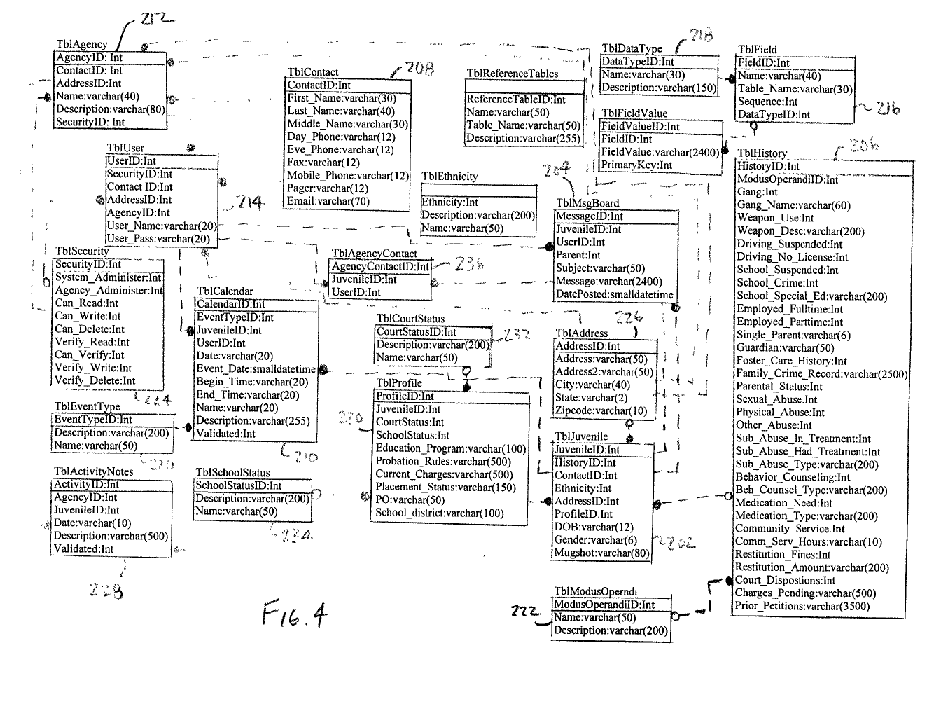

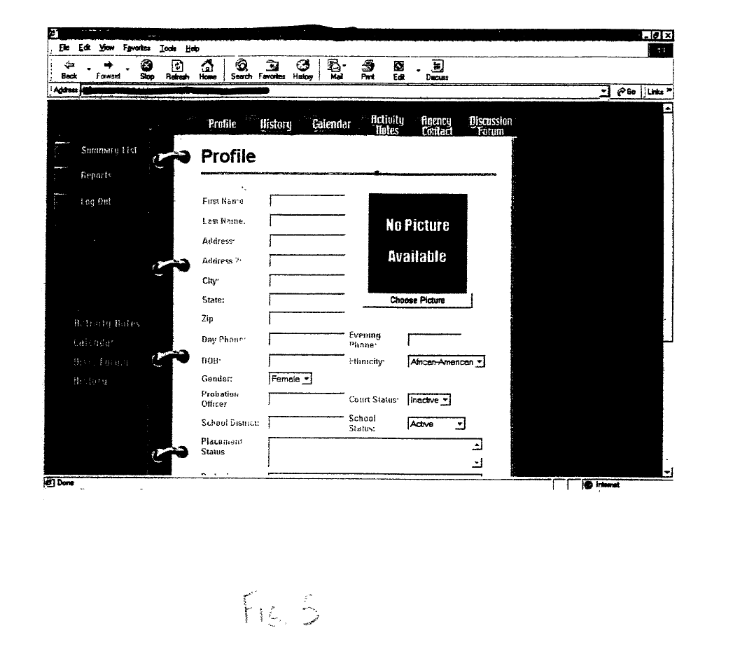

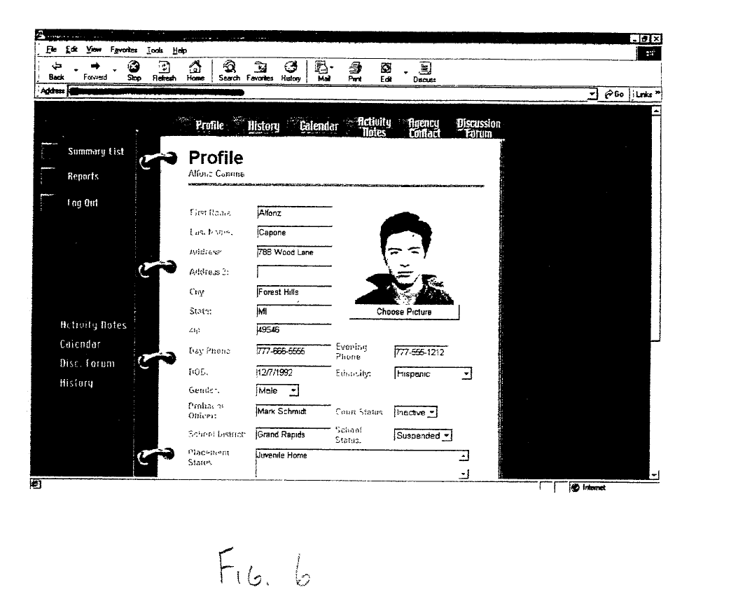

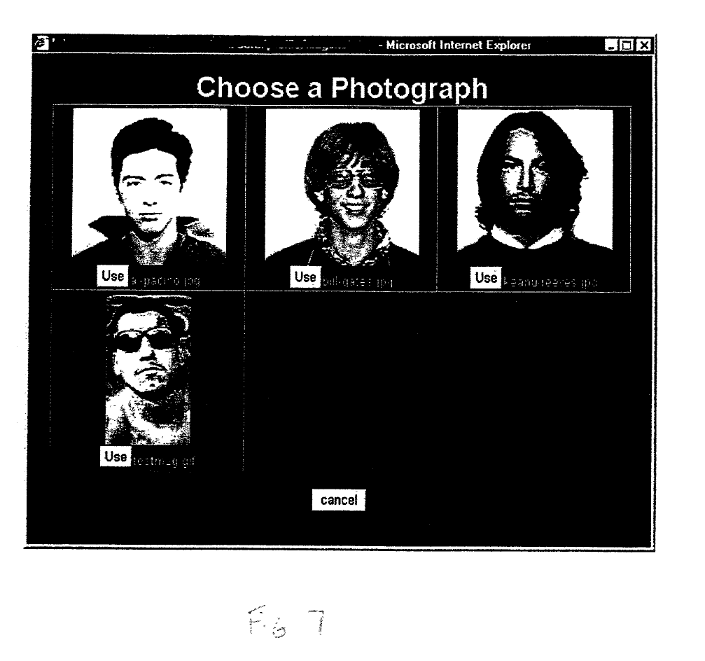

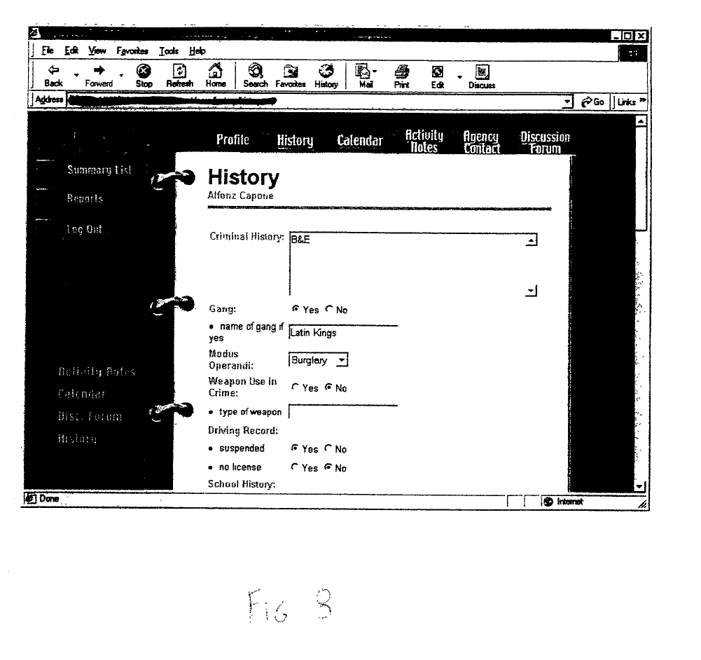

The second software component is the data collection component. The data collection component includes a graphical user interface (“GUI”) that provides for collection of data from an administrator or any of a number of remote users via a client workstation over the computer network or Internet. The GUI facilitates the collection of relevant demographic and historical data by providing data entry fields, pull down menus and other data input mechanisms. The categories and type of data collected for a specific case can vary from application to application through corresponding changes in the GUI. In the described embodiment, the data collected by this component preferably includes, but is not limited to, name, age, contact information (e.g. phone number, facsimile number, email address), physical address, educational background and status, criminal background, court status, treatment background (e.g. counseling, rehabilitation, medical treatment), and family history. A more detailed list of the various data fields collected for each juvenile is available by review of FIG. 4, which illustrates the community database. In a preferred embodiment, the data collection component includes two distinct GUI pages. The first GUI page provides primarily for the input of demographic information. FIGS. 5-6 are screen shots of a portion of the first GUI page. FIG. 5 shows this GUI without any information entered. FIG. 6 shows the same portion of the first GUI after information has been entered. FIG. 7 shows the GUI used to select the picture to be associated with each juvenile. The second GUI page provides primarily for the input of other historical information associated with the juvenile, such as criminal history, gang affiliation and other similar types of information. FIG. 8 is a screen show showing a portion of the second GUI page.

The information collected by the data collection component is stored in a community database, which, as described in more detail below, is a relational database including a variety of interrelated and cross-indexed tables. The community database is configured with a high degree of table segregation to provide a highly relational database.

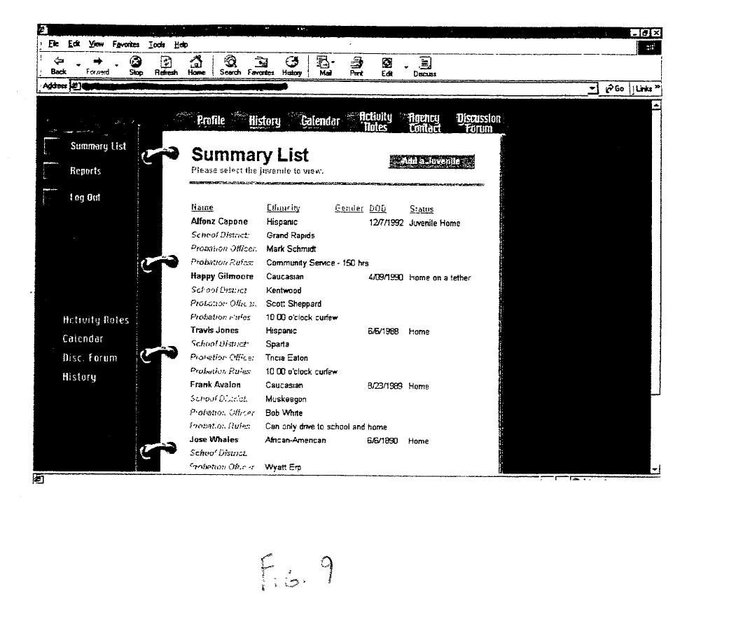

The case management component includes a graphical user interface that permits review of collected data, as well as entry of additional case management data. The case management component preferably includes a function to provide a summary list all of the cases maintain in the community, for example, each of the juveniles entered into the system. The list includes identification information for each case, as well as select information regarding the case. FIG. 9 is a screen shot showing a portion of a summary list. In the described embodiment, the name, ethnicity, gender, date of birth, status, school district, probation officer and probation rules data are displayed in the summary list. The categories of data displayed in the summary list will vary from application to application.

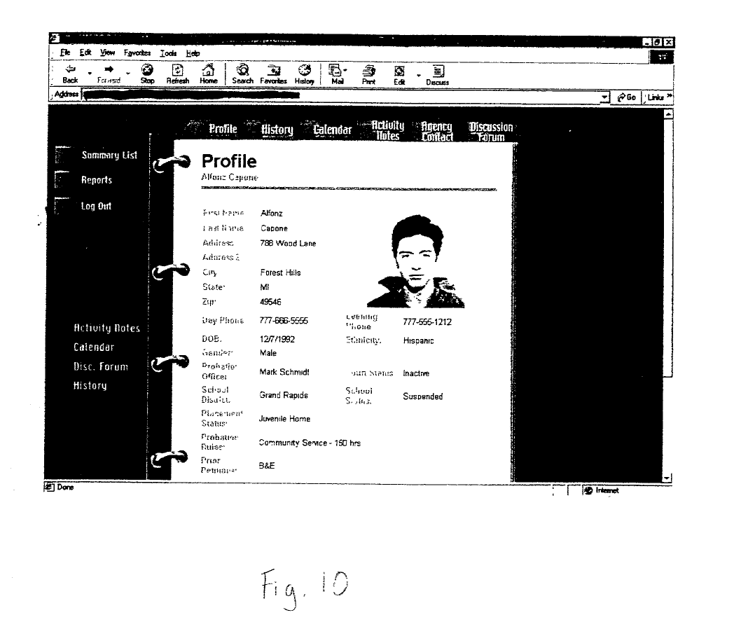

The case management component preferably includes a series of selectable display screens that display selected categories of data for each case or juvenile. The case management component preferably provides a profile display screen that displays select data collected on a case, such as demographic and key historical date. This display screen preferably includes a photo of the juvenile. The user reaches the profile display screen for a particular juvenile by selecting the juvenile's name, for example, by double clicking, in the summary list. FIG. 10 is a screen shot showing a portion of the profile display screen for a specific juvenile. The case management component preferably includes an edit function to permit a user with appropriate security privilege to edit the information displayed on the profile display screen.

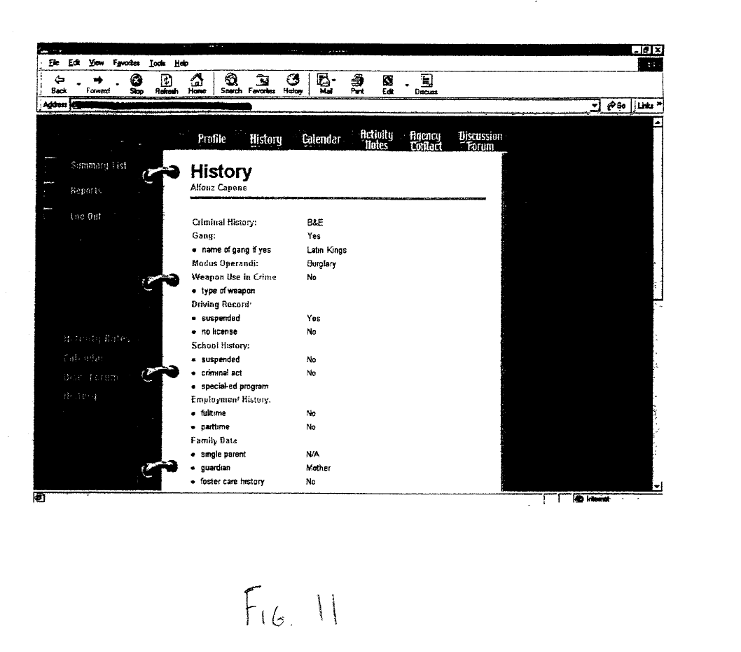

The case management component also preferably includes a historical display screen that displays select historical information collected on a case. This display screen is reached by selecting the screen from the profile display screen, for example, by double clicking on a corresponding tab. FIG. 11 is a screen shot showing a portion of a historical display screen for a specific juvenile. In the described embodiment, the history display screen includes the following information:

1. Criminal History (same as on profile display screen)

2. Gang (yes-no)

name of gang if yes

3. Modus Operandi (notation entry)

4. Weapons use in crime (yes-no)

type of weapon

5. Driving record

suspended (yes-no)

no license (yes-no)

6. School History

suspended (yes-no)

criminal act (yes-no)

special-ed program (notation entry)

7. Employment History

fulltime (yes-no)

part time (yes-no)

8. Family data

single parent (mother-father)

guardian (notation entry for relative)

foster care history (yes-no)

family criminal record (notation entry)

parental status (is a parent—yes/no)

9. Victimization (yes-no)

sexual abuse (yes-no)

physical abuse (yes-no)

other (notation entry)

10. Substance Abuse

In Treatment (yes-no)

Formerly in treatment (yes-no)

Type of substance abuse (notation entry)

11. Behavioral counseling (yes-no)

Type of Counseling (notation entry)

12. Medication needs (yes-no)

type of current medication (notation entry)

13. Community Service ((yes-no)

Hours Ordered (notation entry)

14. Restitution fines (yes-no)

Amount (notation entry)

15. Court dispositions (yes-no)

Charges pending (notation entry)

The case management component preferably includes an edit function to permit a user with appropriate security privilege to edit the information displayed on the history display screen.

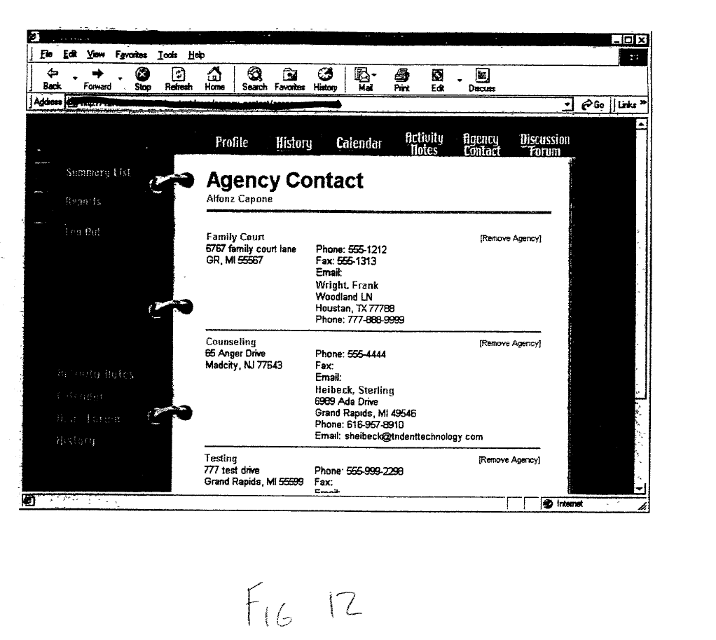

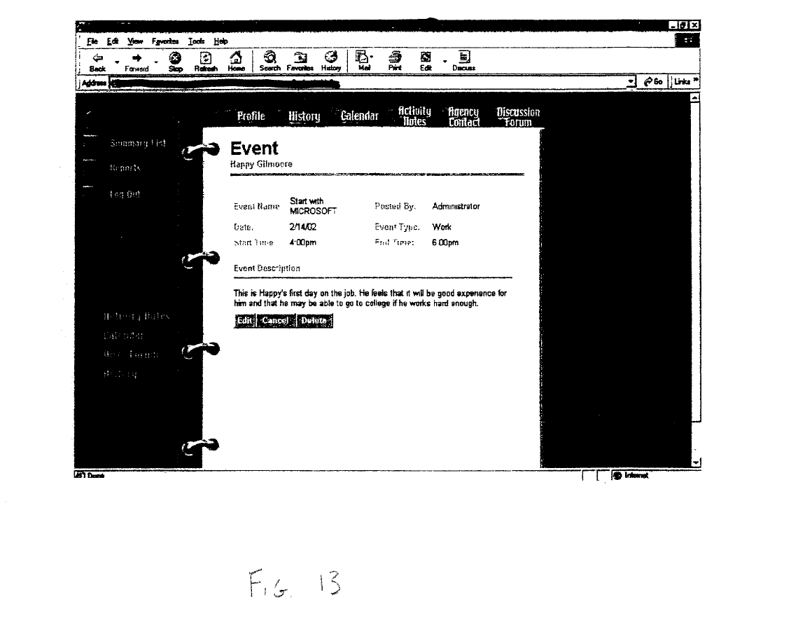

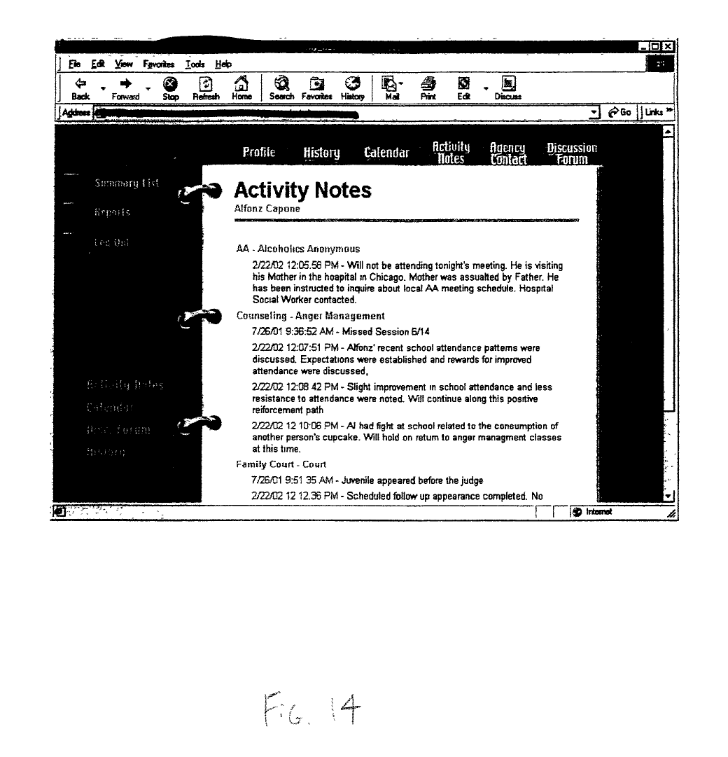

The case management component preferably includes an agency contact display screen that displays select contact information on a case, preferably divided by agency. The agent contact display screen is reached by selecting the screen from the profile display screen, for example, by double clicking on an Agency Contact tab. FIG. 12 is a screen shot showing a portion of an agency contact display screen for a specific juvenile. The system may provide a function to permit a user with appropriate security privilege to edit the agency contact information for a juvenile. In the described embodiment, this function is achieved by first selecting an agency to edit and then selecting the selecting or de-selecting the contacts associated with the agency. FIG. 13 shows a screen shot of the agency selection screen with a drop down box for each agency. FIG. 14 shows a screen shot the contact selection screen with a check-box for each contact in the agency.

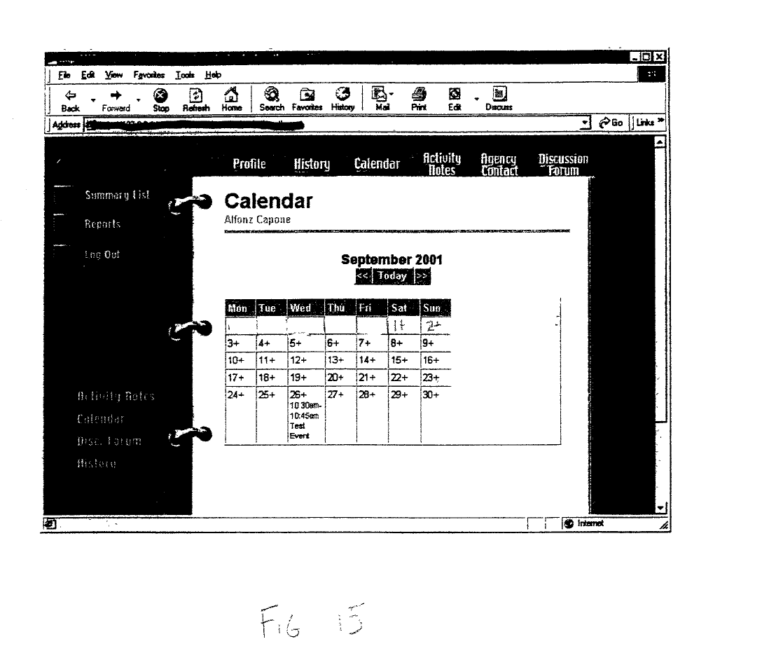

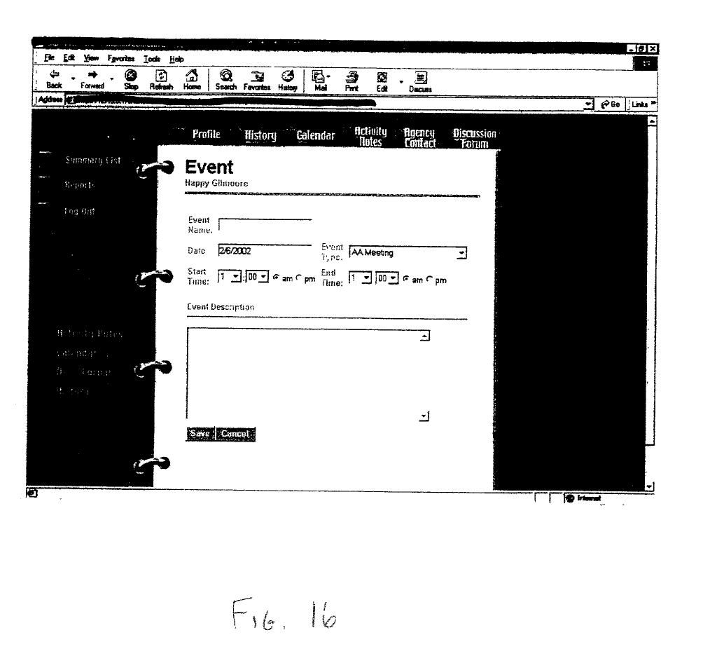

The case management component preferably includes a calendar database that maintains time-specific case management information for each case. The time-specific information is preferably maintained in a calendar table having a separate record for each event. The case management component preferably includes a function that permits viewing of case-specific calendars (e.g. calendars are generated and displayed to show the events of only a single specified juvenile). FIG. 15 is a screen shot showing a calendar display for a single juvenile. If desired, a community-wide calendar may be generated and displayed. An event display screen containing all relevant data can be viewed by selecting the event in the calendar. FIG. 13 is a screen shot showing an event display screen. Events are added to the database through an event GUI. This GUI is reached by selecting the “+” displayed on the calendar date on which the user intends to add an appointment. FIG. 16 is a screen shot showing an input screen for an event. The types of data collected for an event may vary from application to application. An event can also be deleted by selecting a Delete Event button within the event display screen.

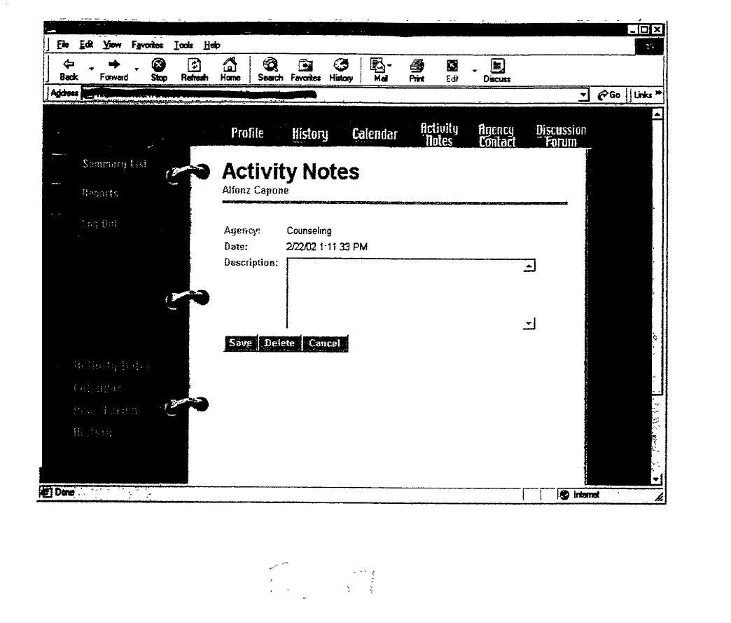

The case management component also preferably includes an activity notes function that permits entry and review of comments and notes on a particular case. FIG. 14 is a screen shot showing an activity notes display screen. The activity notes are preferably stored in a table that is indexed by agency and juvenile, thereby permitting selective entry and review of the activity notes. Activity notes are preferably associated with each event entered into the calendar, for example, in a free form text input box displayed on the event display screen. In addition, activity notes may be entered separately from events using a separate input screen. FIG. 17 is a screen shot showing the activity notes input screen of the described embodiment.

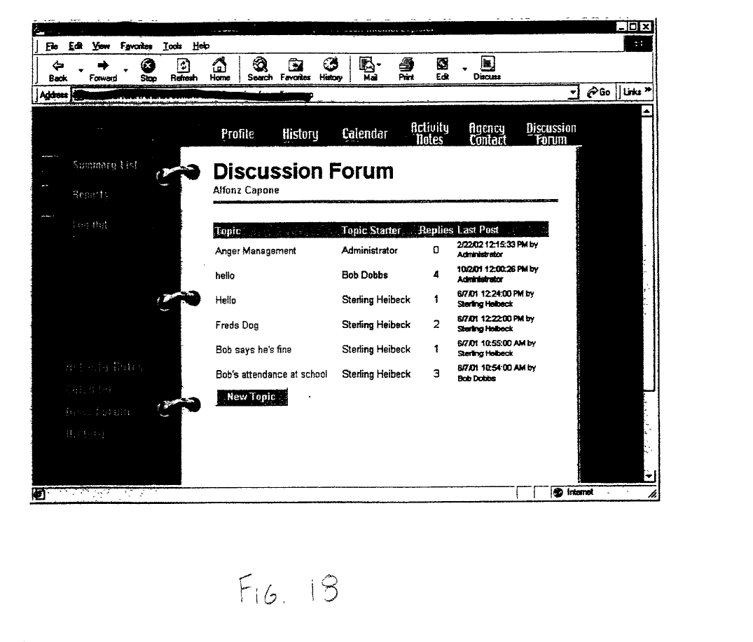

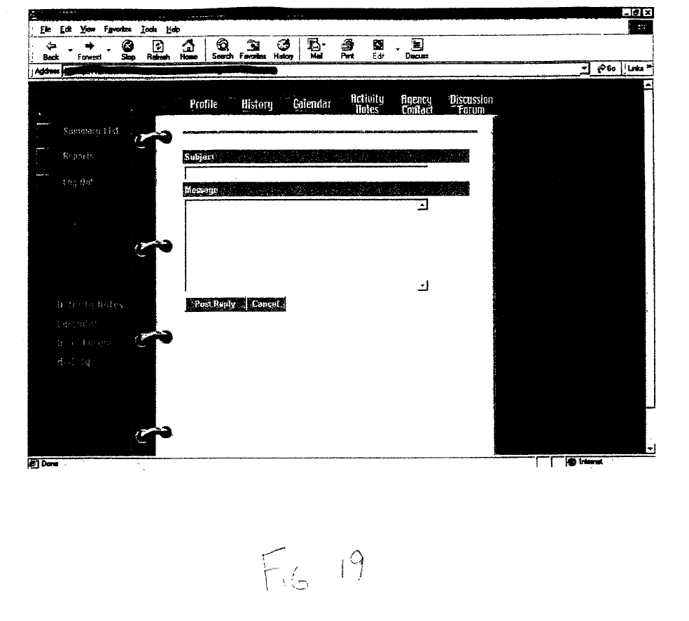

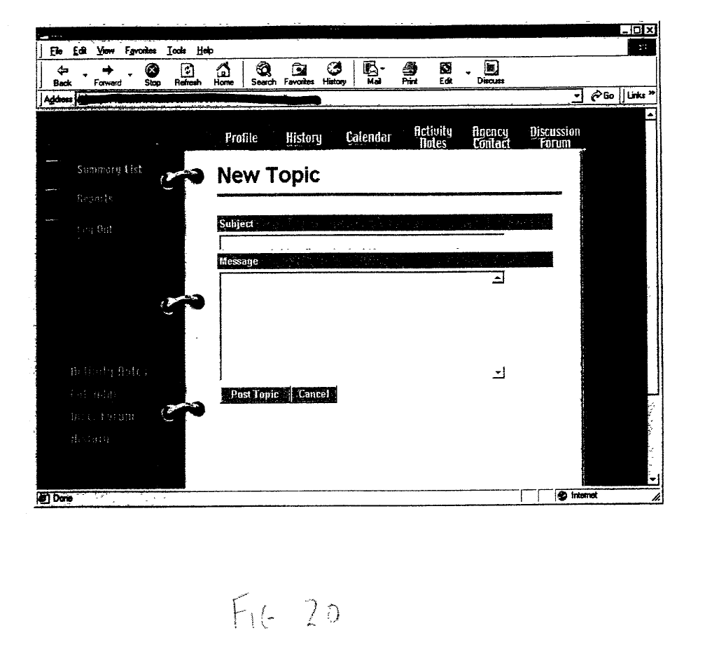

The communications component permits web-based communication between different users of the case management system, for example, in the described embodiment, between two different users providing management to a specific juvenile. The communications component can be implement in real time using conventional web-based “chat” technology. In the preferred embodiment, however, the communications are established using a message board (or bulletin board type) system. The community database includes a separate message board for each of the juveniles entered into the system. Any user having access to a particular case is permitted to review and add messages to the message board. This facilitates communications between users and even between agencies. The message board for each juvenile is preferably indexed by topic. FIG. 18 is a screen shot showing the discussion topics for a specific juvenile. The message board permits a user to post a reply to a specific message or to create a new message. FIG. 19 is a screen shot showing a reply screen. FIG. 20 is a screen shot showing a new topic input screen.

The communications component also includes an aspect that is incorporated into the agency contact display screen discussed above in connection with the case management component. More specifically, the agent contact display screen includes the email address of the various contacts associated with the juvenile. A user can send a private email to any contact simply by selecting that contact, for example, by double clicking on the email address. This facilitates private user-to-user communications.

The report generator component permits the generation of reports containing essentially any data field contained in the system databases. The report generator functions using conventional SQL query tools, and therefore will not be described in detail. Suffice it to say that the report generator may include standard reports and permit the creation of custom reports. The standard reports are based on pre-created SQL queries and pre-created output templates. The generation of custom reports is achieved by permitting a user to create SQL queries and define the output format for the data retrieved by the SQL query.

III. Databases.

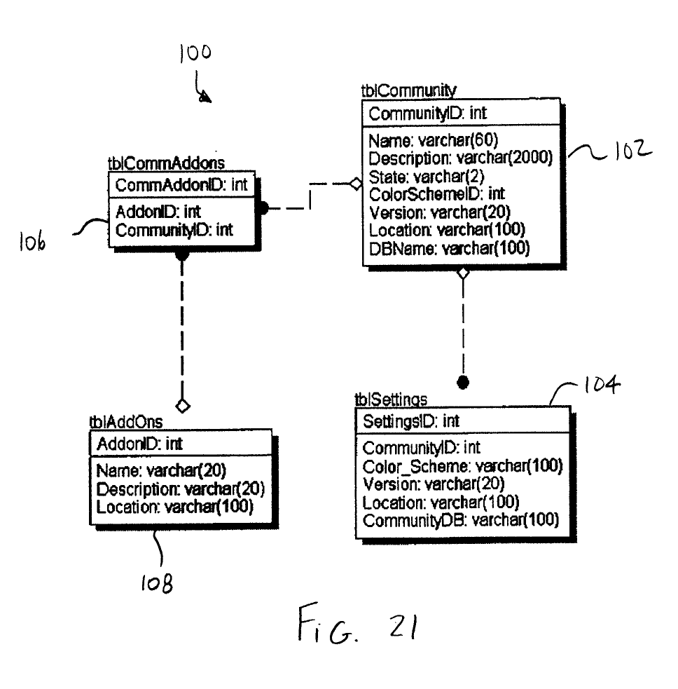

The data collected by the system is maintained in separate relational databases created using structured query language (“SQL”). As a result, the data is easily queried, manipulated and maintained using conventional SQL query tools. The first database maintained by the system is the core database. This database includes information concerning each of the communities maintained on the host computer. A diagram showing the showing the structure of the core database of a preferred embodiment of the present invention is contained in FIG. 21. With reference to FIG. 21, the core database 100 of this embodiment includes the following fields:

1. TblCommunity 102

Information about each community that is running the application. This table includes a ColorSchemeID field that identifies the color scheme assigned to the community.

2. TblSettings 104

Preferences for each community that is running the application.

3. TblCommAddons 106

A list of add-ons that each community has above and beyond the core application. This table will include pointers to any external source code for custom add-ons developed for the case management system.

4. TblAddons 108

A list of all available add-ons and any pertinent information

The system further includes a separate community database for each community maintained on the host computer. In general, each community database includes information concerning the agencies associated with the community, as well as the users that have access to the system. Each community database further includes information concerning the specific cases being managed by the system, for example, in the described embodiment this includes information for each of the juveniles being monitored through the system. The community database 200 of the preferred embodiment is described in more detail in connection with FIG. 4. As shown, the community database 200 includes the following fields:

1. TblJuvenile 202

This table includes a record for each juvenile in the database. Among other things, this table includes a ContactID field that indexes to the TblContact table, a HistoryID field that indexes to the TblHistory table, AddressID field that indexes to the TblAddress table and a ProfileID field that indexes to the TblProfile table.

Various demographic data

Highly customizable, but comes with some base fields that will not be removable

2. TblMsgBoard 204

This table includes a record for each message. In general, each juvenile will have a separate message board where the people responsible for his case can hold discussions. Among other things, this table includes a JuvenileID field that indexes to the TblJuvenile table, a UserID field that indexes to the TblUser table, a subject field, a message field and a date posted field. The system preferably maintains links between each message and any reply messages that are entered. This is achieved by including a ParentID field in each message record that contained the MessageID of any parent message (e.g. the prior message that this message is replying to).

3. TblHistory 206

This table contains a record for each juvenile indexed by the HistoryID field in the TblJuvenile table. This contains all the history of activities reported about a juvenile. The various fields contained in this table for the preferred embodiment are described above.

4. TblContact 208

This table includes an entry for each agency, contact, juvenile and user. The table includes certain demographic information concerning the agency, contact, juvenile or user, and includes a ContactID field that is indexed by, among other things, the TblAgency table, TblUser table and TblJuvenile table.

5. TblCalendar 210

This table includes a record for each time-based event, and includes, among other things, an EventTypeID field that is an index to the ThlEventType table, a JuvenileID field that is an index to the TblJuvenile table, a UserID field that is an index to the TblUser table, Event_Date field specifying the event date, Begin_Time field specifying the beginning time of the event, End_Time field specifying the ending time of the event, Name field and Description field.

6. TblAgency 212

This table includes a record for each agency. The record defines the agency by the AgencyID field and includes, among other things, a ContactID field to index to the agency's record in the TblContact table. The ThlAgency also includes fields for other available information

7. TblUser 214

This table includes a record for each user established in the community. The table includes a ContactID field that indexes to the TblContact table, a SecurityID field that indexes to the TblSecurity table to establishing the user's rights on the system, AgencyID field that indexes to the TblAgency table to associate a user with an agency, an AddressID field that indexes to the user's address in the TblAddress table, a User_Name field for the user's user name and a User_Pass field for the user's password.

8. TblField 216

Describes any “add-on” fields that may be defined by the administrator. The case management system preferably permits the administrator to add new fields to one or more of the table contained in the community database. This permits the administrator to customize the database to meet the needs of a particular community. This functionality is achieved by building a table containing a record for each “add-on” field. The table includes, among other things, a Name field for the name of the add-on filed, a Table_Name field for the name of the table to which the add-on filed is to be added and a Datatype field indexed to the TblDataType table.

9. TblDataType 218

This table includes a record for each of the available data types for the fields created in the ThlField table.

10. TblEventType 220

This table includes a list of the types of events available for the calendar module.

11. TblModusOperandi 222

This table includes a record for each of the possible crime types. This table includes, among other things, a ModusOperandi field that is indexed by the TblHistory table.

12. TblSecurity 224

This tables includes a record for each user and each agency, and stores information about the security levels for each user and each agency

13. TblAddress 226

This table includes a record for each agency, user, contact and juvenile, and stores the address for each. This table includes an AddressID field that is indexed by all other tables requiring address information

14. ThlActivityNotes 228

This table includes a record for each activity note. The table includes, among other things, an AgencyID field to index the activity note to a specific agency, a JuvenileID field to index to a specific juvenile, as well as Date and Description fields.

15. TblProfile 230

This table includes a record for each juvenile. The table includes, among other things, a JuvenileID field to index to the Tbl Juvenile table, and various fields storing select demographic and other profile type information about the juvenile.

16. TblCourtStatus 232

This table includes a record for each type of court status that is recognized by the system, including names and descriptions.

17. TblSchoolStatus 234

This table includes a record for each type of school status that is recognized by the system, including names and descriptions.

18. TblAgencyContact 236

This table includes a record for each association between a user and a juvenile.

The community database described above is provided to facilitate disclosure of the present invention by providing a concrete example. The specific content and design of the community may vary from application to application as desired.

The present invention preferably includes an extensible markup language (“XML”) data set that makes the data highly transportable and easily cross platform compatible. In operation, the system reads the XML data and renders it into HTML using style sheets generated using the extensible stylesheet transformation language (“XSLT”) component of extensible stylesheet language (“XSL”). The XSL style sheets are preferably specially configured to render the entire GUI for each of the relevant web-pages or display screens. This is in stark contrast to conventional XSL systems in which the style sheets are configured to format and embed the rendered code within a static GUI. This permits any add-on data fields (discussed above) to be readily incorporated into the various GUI screens. In operation, the GUI rendering component first parses and renders the standard data from the community database. Second, the GUI rendering component parses the ThlField table searching for any add-on fields associated with the Table-Name corresponding to the current rendering process. If any associated add-on fields are located, they are rendered along with the standard data.

The above description is that of a preferred embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1- A computer case management system comprising:
a communication network;
a host computer connected to said communication network;
a plurality of client workstations connected to said communication network;
wherein the host computer includes:
a community database including data representative at least one community, said at least one community including data representative of a plurality of agencies and data representative of a plurality of users, each of said users being associated with one of said agencies, each of said users being permitted access to said community database on said host computer from a remote location via at least one of said client workstations, said community database further including a plurality of cases;
a data collection component to collect data for a plurality of cases in a community database maintained on said host computer, said data collection component including means for collecting data over said communication network through data entry on said client workstations, said system including means for associating each of said cases with at least one user;
a case management component to permit viewing of said data, said case management component including means for permitting viewing of said data for a particular one of said cases only by said users associated with said particular case;
a communication component permitting communication between distinct users associated with at least one of said cases, said communication component including means for entering, storing and viewing messages associated with said case, said messages being accessible only to said users associated with said case; and
a calendar component permitting entry, storage and review of time-specific events associated with at least one case, said calendar component including a means for associating each of said events with a corresponding one of said cases, said events being accessible only to said users associated with said case.

2- The system of claim 1 wherein said host computer further includes an administrator component for permitting an administrator to define said community by defining said agencies and said users.

3- The system of claim 2 wherein said case management component further including means for permitting a user associated with a particular one of said cases to enter additional data associated with said particular case, said additional data being viewable along with said data for said particular case by said users associated with said case.

4- The system of claim 3 wherein said host computer further includes a report generator component for generating reports of said data and said additional data in said community database, said community database being a relational database, said report generator component including means for querying said community database using relational database queries.

5- The system of claim 4 wherein said administrator component includes add-on means for adding additional fields to said community database, said add-on means including means for storing in said community database an add-on field, a data type of said add-on field and a table identifier identifying a database table to which said add-on filed is to be added, said add-on means further including means for appending each of said add-on fields to each input screen and output screen associated with said table.

6- The system of claim 5 further comprising a tracking component, said tracking component including means for storing by user a record each time said user logs into said system, logs out of said system and accesses said data.

7- The system of claim 6 wherein said case management component includes means for entering, storing and viewing activity notes, said case management component including means for associating each of said activity notes with a particular one of said cases, said activity notes being accessible only to said users associated with said particular case.

8- The system of claim 7 wherein said case management component includes means for associating each of said activity notes with one of said events.

9- The system of claim 8 wherein said data stored in said community database is an extensible markup language data set, said system including extensible markup language transformation means for parsing said extensible markup language data set and rendering it in hypertext markup language.

10- The system of claim 9 wherein said system includes extensible markup language style sheets for rending said data, said add-on means including means for modifying said style sheets to add said add-on fields to all input screens and output screens associated with said table.

11- The system of claim 10 wherein said administrator component further includes means for selecting a color scheme for all input screens and output screens, said color scheme being defined by variables embedded in said style sheets, said administrator component providing means for reassigning color values to said variables to effect a color scheme change across all input screens and output screens.

12- A computer case management system comprising:
a computer network having a host computer connected to a plurality of client workstations via a communication network; the host computer including:
an administrator component to define a community by defining a plurality of agencies and a plurality of users, each of said users being associated with one of said agencies, community data representative of said agencies and said users being stored in a community database;
a data collection component to collect case data for a plurality of cases, said system including means for associating each of said cases with at least one of said users, said case data for said cases being stored in said community database;
a case management component to permit viewing of said case data by one of said users at a client workstation via communications with said host computer, said case management component including means for limiting viewing of said case data for a particular one of said cases to only those of said users associated with said particular case;
a communication component permitting communication between distinct users associated with at least one of said cases, said communication component including means for entering, storing and viewing messages associated with said case, said messages being accessible only to said users associated with said case; and
a calendar component permitting entry, storage and review of time-specific events associated with at least one case, said calendar component including a means for associating each of said events with a corresponding one of said cases, said events being accessible only to said users associated with said case.

13- The system of claim 12 wherein said case management component further including means for permitting a user associated with a particular one of said cases to enter additional data associated with said particular case, said additional data being stored in said community database and being viewable along with said data for said particular case by said users associated with said case.

14- The system of claim 13 wherein said case management component includes means for entering, storing and viewing activity notes, said case management component including means for associating each of said activity notes with a particular one of said cases, said activity notes being accessible only to said users associated with said particular case, said case management component further including means for associating each of said activity notes with one of said events.

15- The system of claim 14 wherein said community database includes a plurality of tables, said administrator component includes add-on means for adding additional data fields to at least one of said tables of said community database, said add-on means including means for storing in said community database an add-on field, a data type of said add-on field and a table identifier identifying a particular one of said tables to which said add-on filed is to be added, said add-on means further including means for appending each of said add-on fields to each input screen and output screen associated with said table.

16- The system of claim 15 wherein said community date and said case data is stored in said community database is an extensible markup language data set, said system including extensible markup language transformation means for parsing said extensible markup language data set and rendering it in hypertext markup language.

17- The system of claim 16 wherein said system includes extensible markup language style sheets for rending said data, said add-on means including means for modifying said style sheets to add said add-on fields to all input screens and output screens associated with said table.

18- The system of claim 17 wherein said administrator component further includes means for selecting a color scheme for all input screens and output screens.

19- The system of claim 18 further comprising a tracking component, said tracking component including means for storing by user a record each time said user logs into said system, logs out of said system and accesses data in said community database.

20- The system of claim 19 wherein said host computer further includes a report generator component for generating reports of select data in said community database, said community database being a relational database, said report generator component including means for querying said community database using relational database queries.
